(19) United States
(12) Patent Application Publication
(10) Pub. No.: US 2018/0008990 A1
(43) Pub. Date: Jan. 11, 2018

(54) CENTRIFUGAL MECHANICAL SEPARATOR PRODUCED BY ADDITIVE MANUFACTURING

(71) Applicant: Tobi D. Mengle, Birdsboro, PA (US)

(72) Inventor: Tobi D. Mengle, Birdsboro, PA (US)

(21) Appl. No.: 15/643,619

(22) Filed: Jul. 7, 2017

Related U.S. Application Data
(60) Provisional application No. 62/359,644, filed on Jul. 7, 2016.

(51) Int. Cl. B04B 1/08; B04B 11/02

(52) U.S. Cl. CPC B04B 1/08; B33Y 80/00; B04B 11/02

(57) ABSTRACT

A centrifugal mechanical separator comprises a disk stack formed by an additive manufacturing process (i.e., 3D printing), where the stack comprises a plurality of disk elements (which may range anywhere from a few to a few hundred). The disk stack is positioned within a proper-sized bowl (with proper inlet and outlet ports), which may also formed using an additive manufacturing process. A bowl cover and inlet/outlet assembly may also be formed using additive manufacturing, where the various dimensions and tolerances of each component (disk stack, bowl, bowl cover, and inlet/outlet assembly) are carefully controlled by the additive manufacturing process, reducing the costs and complexities associated with traditional centrifuge manufacture.

### CROSS-REFERENCE TO RELATED APPLICATIONS

This application claims the benefit of U.S. Provisional Application Ser. No. 62/359,644, filed Jul. 7, 2016 and incorporated herein by reference.

### TECHNICAL FIELD

The present invention relates to a centrifugal mechanical separator and, more particularly, to a centrifugal mechanical separator formed of components created using additive manufacturing processes.

### BACKGROUND OF THE INVENTION

Centrifugal mechanical separators (i.e., centrifuges) are used in industry to separate solids from liquids, as well as to separate higher density liquids from lower density liquids. Typical large-scale uses include, but are not limited to, clarifying beers and wines, continuous cleaning of lubrication and cooling oils, and waste water treatment. Centrifuges are also used extensively in the chemical and pharmaceutical industries to separate and clarify various products.

Centrifuges are typically made from metals, since the moving parts are subjected to substantial forces and need to be constructed of materials having high strength and durability. The various components of a centrifuge are fabricated using traditional “subtractive” processes, such as milling and turning on cutting tool machines. The number of separate components required to make a fully assembled machine is often dictated by the method of manufacturing. Typical centrifuges can have tens to hundreds of parts and require an equal number of sealing gaskets and o-rings to confine the process fluid within a well-defined path through the machine.

As a result of the numerous components and various machining processes required to manufacture them, typical centrifuges become quite complex, with the inevitably long construction time line. These circumstances have led some manufacturers to standardize on certain designs and sizes of centrifuges. These designs may not be well suited to a specific set of process requirements for a given customer, so the customer is forced to compromise and use a machine that may be bigger (or smaller) than actually needed for their process. This compromise in sizing results in inefficiencies and waste in both time and material, and limits the process designer in terms of options for process optimization based on the economics of producing a centrifuge of an optimum size for a particular purpose.

### SUMMARY OF THE INVENTION

The needs remaining in the prior art are addressed by the present invention, which relates to a centrifugal mechanical separator (i.e., centrifuge) and, more particularly, to a centrifuge formed of components created using additive manufacturing processes.

In accordance with one or more embodiments of the present invention, a centrifuge comprises a disk stack formed by an additive manufacturing process (i.e., 3D printing), where the stack comprises a plurality of disk elements (which may range anywhere from a few to a few hundred). The disk stack is positioned within a proper-sized bowl (with proper inlet and outlet ports), which may also be formed using an additive manufacturing process. A bowl cover and inlet/outlet assembly may also be formed using additive manufacturing, where the various dimensions and tolerances of each component (disk stack, bowl, bowl cover, and inlet/outlet assembly) are carefully controlled by the additive manufacturing process, reducing the costs and complexities associated with traditional centrifuge manufacture. The “scale” of the machine and the assembled sub-components, either larger or smaller, is limited only by the capabilities of the additive manufacturing process itself.

It is an aspect of the present invention that straight-forward modifications to the additive manufacturing process may be used to tailor the number of separate disks within a stack for a given purpose. Additionally, the overall dimensions of the disk stack and shape of the frusto-conical form are easily defined and controlled by the additive manufacturing process, enabling an improvement in the efficiency of separation between materials introduced to the centrifuge.

One exemplary embodiment of the present invention takes the form of An additively manufactured centrifugal mechanical separator comprising a rotatable bowl enclosure including at least one outlet port for directing a first separated component of a first density out of the centrifugal mechanical separator, a plurality of additively manufactured frusto-conical disks disposed as a disk stack within the rotatable bowl enclosure, the disk stack include a central aperture for receiving incoming material to be separated, an inlet channel disposed through an opening in the rotatable bowl enclosure and extending into the central aperture for introducing incoming material into the centrifugal mechanical separator, and an outlet channel disposed through the opening in the rotatable bowl enclosure for directing a second separated component of a second density out of the centrifugal mechanical separator.

Other and further aspects and embodiments of the present invention will become apparent during the course of the following discussion and by reference to the accompanying drawings.

### BRIEF DESCRIPTION OF THE DRAWINGS

Referring now to the drawings,

FIG. 1 is a cut-away, simplified side view of a conventional prior art disk stack centrifuge;

FIG. 2 is an isometric view of an exemplary centrifuge bowl, formed using an additive manufacturing process in accordance with the present invention;

FIG. 3 is an isometric view of an exemplary disk stack, formed using an additive manufacturing process in accordance with the present invention;

FIG. 4 is an isometric view of an exemplary centrifuge bowl cover, formed using an additive manufacturing process in accordance with the present invention; and

FIG. 5 is an isometric view of an exemplary centrifuge inlet/outlet assembly, which may be formed using an additive manufacturing process in accordance with the present invention.

### DETAILED DESCRIPTION

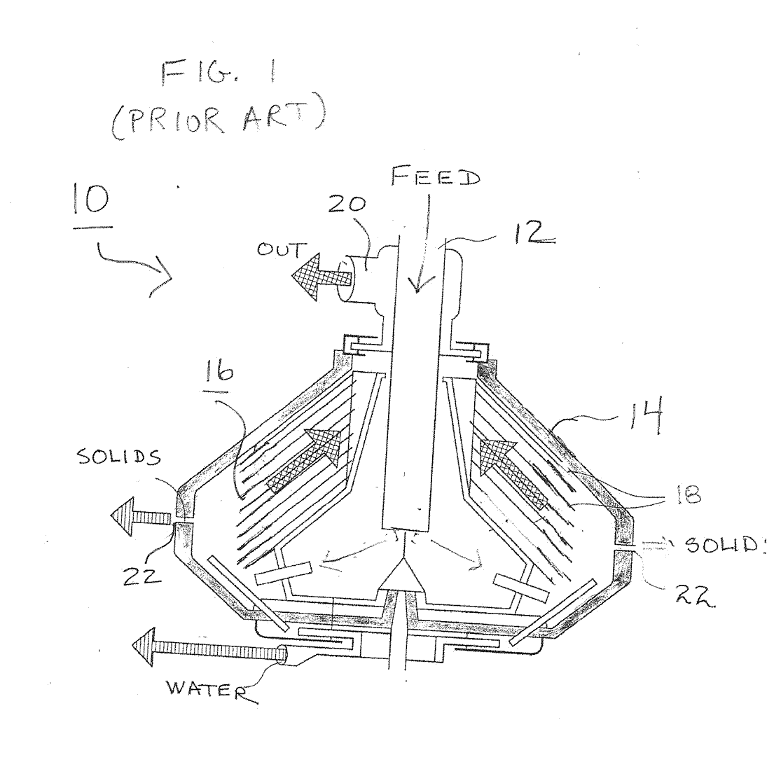

Prior to describing the various features and improvements associated with the present invention, a description of the working of a conventional disk stack centrifuge will be described in association with the illustration shown in FIG. 1.

A disk stack centrifuge 10 is generally shown in FIG. 1 to include a stationary inlet pipe 12 through which the incoming process material enters centrifuge 10. Centrifuge 10 further comprises a bowl 14 which rotates to generate the centrifugal forces that separate the various components contained in the incoming process material (i.e., separating solids from liquids, or higher density liquids from lower density liquids, etc.). A disk stack 16 comprising a plurality of separate frusto-conical disks 18 is positioned within the center of bowl 14 in the manner shown in FIG. 1. The multiple surfaces created by disk stack 16 ensure that the incoming flow of process material is evenly spread out among disks 18, facilitating the efficient separation between solid/liquid or heavy/light (or both). A light phase outlet 20 allows for the output of the lower density liquid from centrifuge 10, with solids and/or heavy phase liquids exiting as shown, where in particular solids exit through numerous ports 22 formed around the circumference of bowl 14.

As mentioned above, the conventional (“subtractive”) machine manufacturing process used to fabricate centrifuge 10, as well as the specific metal materials available for use in fabricating such a machine, limit the use of these centrifuges to processes that are compatible with metals. Chemical processes that use strong acids, bases, or other highly-corrosive liquids cannot be processed through metal machines because of corrosion and the subsequent loss of material strength within one or more components of a centrifuge. Inasmuch as the very nature and application of a centrifuge is to be subjected to high degrees of centrifugal force, any possibility of loss of material strength is very problematic. While it is possible to fabricate centrifuges from other materials, the small-sized markets and demands for such products (as well as higher materials costs) make them uneconomical.

Thus, various aspects of the present invention address these concerns by utilizing the positive attributes of additive manufacturing (at times, referred to as “3D printing” in the art) to fabricate a centrifuge in a manner that enables the use of corrosive-resistant materials and individual design (particularly of the disk stack) to address a particular customer application.

The use of additive manufacturing allows for the design of a centrifuge to be substantially altered when compared to the prior art machining process, providing benefits such as (but not limited to): reducing the total part count, reducing construction time, allowing economic use of alternative corrosion-resistant materials, optimizing size and configuration of components (again, particularly the disk stack). In particular, the use of additive manufacturing has been found to significantly expand the type of materials that may be used in the formation of machines such as centrifuges. For instance, direct metal laser sintering can directly “build” on stainless steel and titanium, among other metals. Other material choices for fabricating a centrifuge using additive manufacturing include, but are not limited to, corrosive-resistant polymers such as polyethylene terephthalate (PET), polymethyl methacrylate (PMMA), and polycarbonate (PC), carbon fiber impregnated filaments, fluoropolymers, and multi-material configurations (i.e., a bowl of one material and a disk stack of another material).

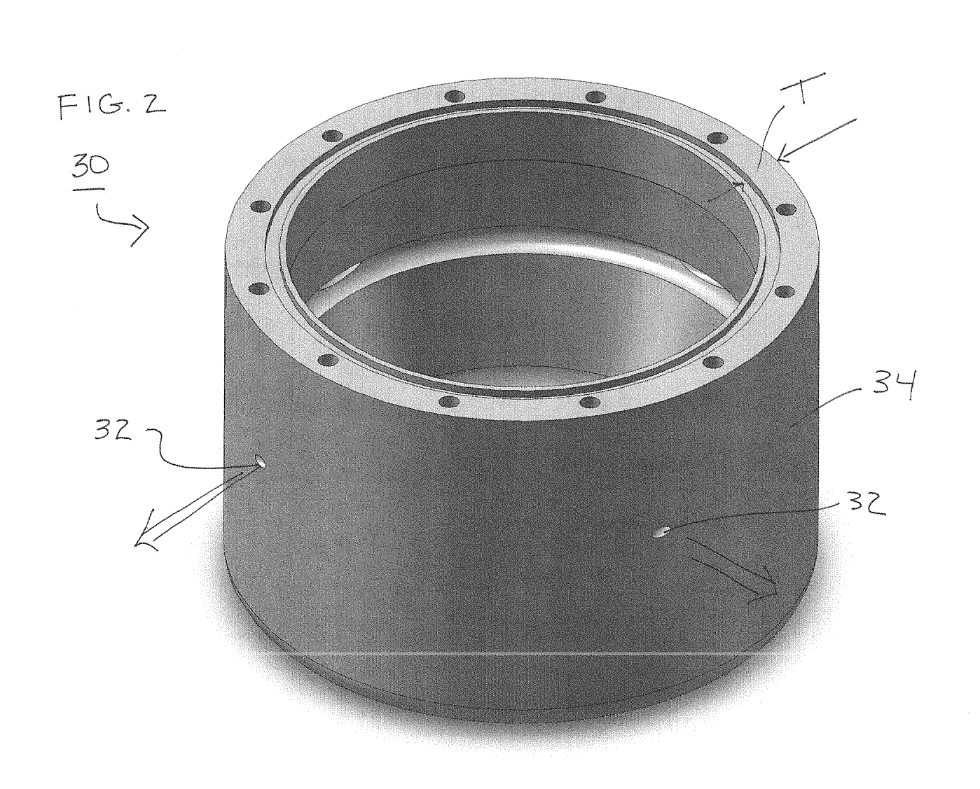

FIG. 2 illustrates an exemplary centrifuge bowl 30 formed by using an additive manufacturing process in accordance with the teachings of the present invention. Centrifuge bowl 30 may be formed of any desired height and diameter, with any desired wall thickness T. A number of solids outlet ports 32 are formed within sidewall 34 of bowl 30 during the additive manufacturing process, where the position of ports 32, as well as their diameter, are controlled by the specifics of the computer process used to perform the additive manufacture.

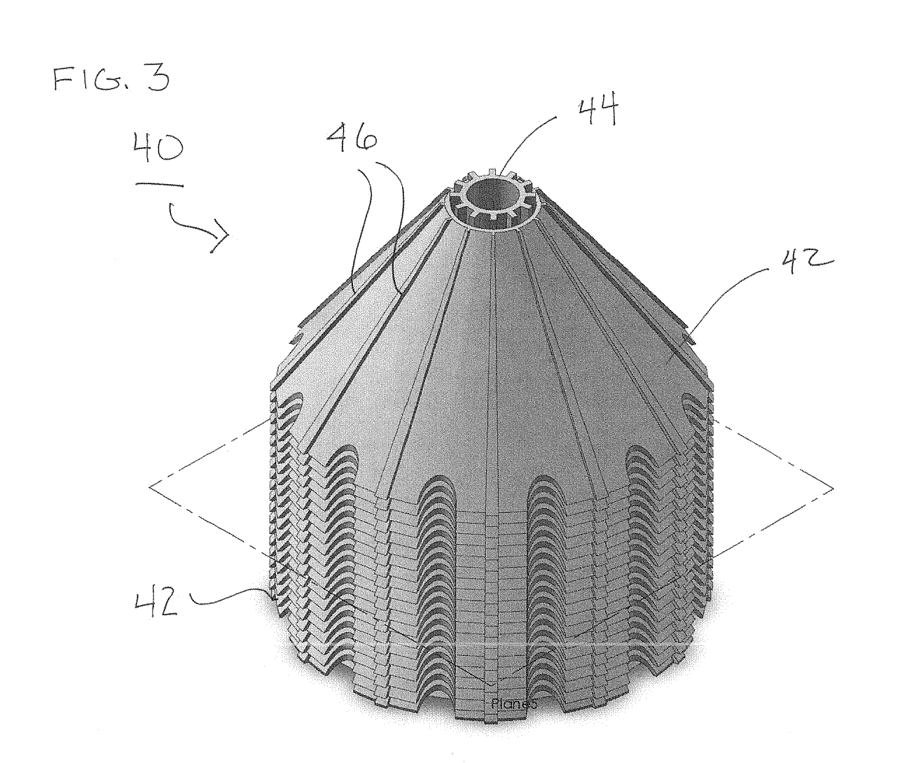

FIG. 3 illustrates an exemplary disk stack 40 formed by using an additive manufacturing process in accordance with the teachings of the present invention. As shown, disk stack 40 comprises a plurality of separate disks 42, each disk 42 being essentially frusto-conical in form. Advantageously, an additive manufacturing process may be used to form disk stack 40 as a single, monolithic component, with the various separate disks 42 connected to each other, and also forming an inlet conduit 44 (for providing the inlet of the process material flow). Alternatively, each separate disk 42 may be formed using an additive manufacturing process, and the separate disks then assembled into the final form as shown in FIG. 3. It is contemplated that there will be applications where the provision of a monolithic disk stack would be advantageous, while it is also contemplated that there will be applications where a user would want to control the number of separate disks within a stack and would prefer the use of individual elements (or smaller units of disks manufactured as a single component, forming a “mini-stack”, so to speak). A benefit of additive manufacturing is that all of these variations are possible.

Another benefit of utilizing additive manufacturing is that the particular surface of a disk may be uniquely designed to address fluid mechanic concerns for a particular application (e.g., densities of materials, quantity of material, etc.). Inasmuch as a centrifuge formed using additive manufacturing in accordance with the present may range in size from micrometers (to handle microfluidic samples) to meters (to handle industrial fluids), the disks themselves sometimes need to be designed to accommodate various types of eddy current and other flow properties associated with the dimensions of the centrifuge. In the exemplary embodiment shown in FIG. 3, each disk 42 is formed to include a plurality of ribs 46 around its periphery, where ribs 46 are included to provide a desired spacing between adjacent disks, as well as a desired fluid flow effect. Other features or textures on surfaces of each disk may easily be incorporated into the additive manufacturing process to address specific concerns associated with a given application.

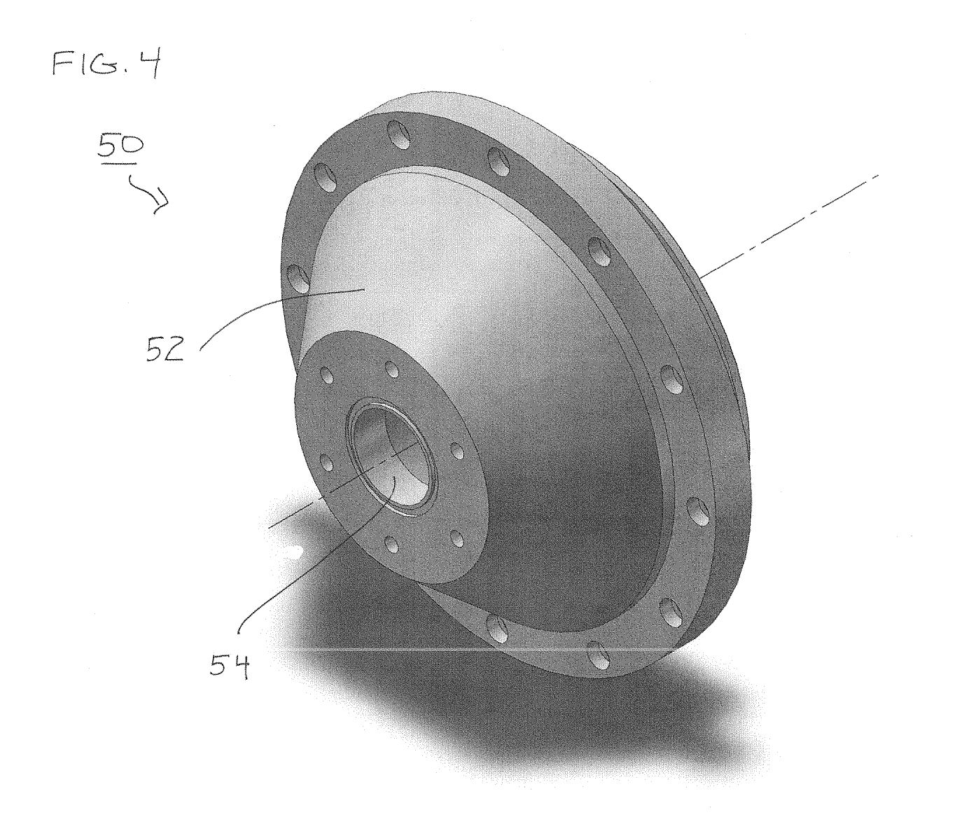

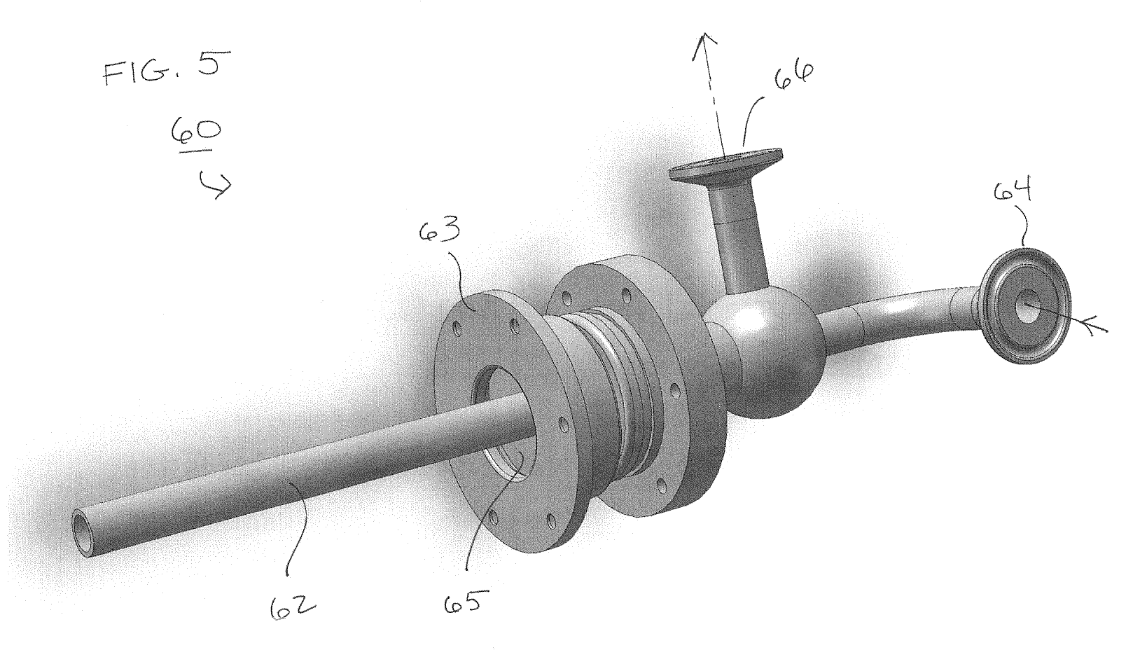

FIG. 4 illustrates a bowl cover 50 that is placed over disk stack 40 after it has been positioned within bowl 30. Bowl cover 50 is shown as having a tapered portion 52 to accommodate the positioning of disk stack 40 within bowl 30. A central aperture 54 is included in bowl cover 50 to permit for the inlet piping (shown in FIG. 5, below) to be inserted into the centrifuge and be positioned within inlet conduit 44 of disk stack 40. An inlet/outlet assembly 60 is shown in FIG. 5. Assembly 60 includes an inlet pipe 62 (which passes through aperture 54 and is inserted in inlet conduit 44), as well as a process material inlet port 64 and a light phase outlet port 66. In a preferred embodiment, a pump cover 63 is produced using an additive manufacturing process so as to be freely moving with respect to a (hidden) stationary centripetal pump 65. This assembly in the prior art required numerous sub-components to be fabricated separately, and many o-ring seals were required to keep the centrifugally-separated process streams separately confined along discharge paths from the machine. Using additive manufacturing in accordance with the present invention allows for inlet/outlet assembly 60 to be fabricated in two pieces with pump cover 63 able to be freely rotating with respect to the feed/discharge assembly, while also keeping the incoming process material separate from the outgoing light phase material.

While the specific embodiments of additively-manufactured centrifuge components shown above are useful in various implementations, it is to be understood that specific centrifuge designs may require different (or altered) components that may also be fabricated using additive manufacturing techniques. For example, auto-discharge centrifuges utilize a bowl component with moving elements and associated channels to provide hydraulic action. It is contemplated that such a bowl configuration may easily be formed using an additive manufacturing technique.

Although centrifuges produced using additive manufacturing techniques may not have the ultimate strength of centrifuges produced by traditional subtractive manufacturing technologies, the ability to produce them at lower cost and an almost infinite range of size and configuration flexibility are considered to be significant advantages. Indeed, as mentioned above, the ability to use various corrosive-resistant materials in additive manufacturing (such as various polymers, carbon fiber filaments, and the like mentioned above) has allowed for centrifugal mechanical separators to be manufactured for use with various acids and other corrosive materials. While these polymer materials do provide the ability to create corrosion-resistant parts, it is to be understood that various metals (and alloys, compounds, etc.) may also be worked in an additive manufacturing process, allowing for “metal printing” to provide centrifuges of increased strength (with respect to polymers) with substantially shorter manufacturing times than conventional metal centrifuges. Indeed, additive manufacturing using titanium is advancing rapidly and would provide both corrosion resistance and strength.

While various elements of the present invention have been described and illustrated in detail, it is to be clearly understood that this is done by way of illustration and example only and is not to be taken by way of limitation. The scope of the present invention is to be limited only by the terms of the claims appended hereto.

What is claimed is:

1. An additively manufactured centrifugal mechanical separator comprising
a rotatable bowl enclosure including at least one outlet port for directing a first separated component of a first density out of the centrifugal mechanical separator;
a plurality of additively manufactured frusto-conical disks disposed as a disk stack within the rotatable bowl enclosure, the disk stack include a central aperture for receiving incoming material to be separated;
an inlet channel disposed through an opening in the rotatable bowl enclosure and extending into the central aperture for introducing incoming material into the centrifugal mechanical separator, and
an outlet channel disposed through the opening in the rotatable bowl enclosure for directing a second separated component of a second density out of the centrifugal mechanical separator.

2. The additively manufactured centrifugal mechanical separator as defined in claim 1 wherein the plurality of additively manufactured disks is formed as a single, monolithic component.

3. The additively manufactured centrifugal mechanical separator as defined in claim 1 wherein the plurality of additively manufactured disks is formed of separate additively manufactured disks, thereafter stacked to form the disk stack.

4. The additively manufactured centrifugal mechanical separator as defined in claim 1 wherein the plurality of additively manufactured disks is formed of a set of mini-stacks, each mini-stack comprising a group of disks additively manufactured as a single, monolithic component with the sets of mini-stacks disposed in a vertical configuration to form a final disk stack.

5. The additively manufactured centrifugal mechanical separator as defined in claim 1 wherein at least one disk is additively manufactured to include surface features for improving flow of materials within the separator.

6. The additively manufactured centrifugal mechanical separator as defined in claim 1 wherein each disk of the plurality of disks forming the disk stack is additively manufactured to include surface features for improving flow of materials within the separator.

7. The additively manufactured centrifugal mechanical separator as defined in claim 6 wherein each disk is formed to include additively manufactured raised ribs along a top surface of the disk from the central aperture to an opposing edge.

8. The additively manufactured centrifugal mechanical separator as defined in claim 1 wherein the bowl enclosure comprises a bowl container for supporting the disk stack and a bowl cover for mating with the bowl container and enclosing the disk stack within the separator.

9. The additively manufactured centrifugal mechanical separator as defined in claim 1 wherein the bowl enclosure comprises an additively manufactured bowl enclosure.

10. The additively manufactured centrifugal mechanical separator as defined in claim 1 wherein the inlet channel comprises an additively manufactured inlet channel.

11. The additively manufactured centrifugal mechanical separator as defined in claim 1 wherein the outlet channel comprises an additively manufactured outlet channel.

12. The additively manufactured centrifugal mechanical separator as defined in claim 1 wherein the plurality of disks is formed of a corrosive-resistant material.

13. The additively manufactured centrifugal mechanical separator as defined in claim 12 wherein the plurality of disks is formed of a corrosive-resistant polymer material.

14. The additively manufactured centrifugal mechanical separator as defined in claim 12 wherein the plurality of disks comprises a corrosive-resistant material selected from the group consisting of: polyethylene terephthalate (PET), polymethyl methacrylate (PMMA), polycarbonate (PC), carbon fiber impregnated filaments, and fluoropolymers.

15. The additively manufactured centrifugal mechanical separator as defined in claim 1 wherein the bowl enclosure, the plurality of disks, the inlet channel, and the outlet channel are all formed of a corrosive-resistant material selected from the group consisting of: polyethylene terephthalate (PET), polymethyl methacrylate (PMMA), polycarbonate (PC), carbon fiber impregnated filaments, and fluoropolymers.

16. The additively manufactured centrifugal mechanical separator as defined in claim 15 wherein the bowl enclosure, the plurality of disks, the inlet channel, and the outlet channel may each comprise a different corrosive-resistant material.

17. The additively manufactured centrifugal mechanical separator as defined in claim 15 wherein the bowl enclosure, the plurality of disks, the inlet channel, and the outlet channel all comprise a same corrosive-resistant material.
